(19) United States
(12) Patent Application Publication
(10) Pub. No.: US 2008/0126659 A1
(43) Pub. Date: May 29, 2008

(54) Variable Field Device For Use In Automation Systems

(75) Inventors: Peter Klöfer, Steinen (DE); Martin Pfandler, Maulburg (DE); Bernd Strutt, Steinen (DE); Jorg Reinkensmeier, Schopfheim (DE)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg (DE)

(21) Appl. No.: 11/597,126

(22) PCT Filed: May 17, 2005
(86) PCT No.: PCT/EP2005/052250

§ 371 Date: Nov. 6, 2007

(30) Foreign Application Priority Data
May 21, 2004 (DE) 10 2004 025 484.2

(51) Int. Cl. G06F 13/00

(52) U.S. Cl. 710/302

(57) ABSTRACT

In a variable field device for use in automation systems, which has a microprocessor for running a control program, and a serial fieldbus interface for communicating with a fieldbus, a parallel communication interface CI is provided as an additional interface, in the form of a standard insertion bay for different interface modules.

The invention concerns a variable field device for use in automation technology, as such device is defined in the preamble of claim 1.

In the field of process automation technology, field devices are used in many cases for measuring and/or influencing process variables. Examples of such field devices are fill level measuring devices, mass flow, e.g. flow rate, measuring devices, pressure and temperature measuring devices, etc., which, as sensors, measure the corresponding process variables fill level, mass flow, pressure, and temperature, respectively.

Serving to influence process variables are actuators, which, e.g. as valves, control the flow rate of a fluid in a section of pipe, or, as pumps, control the fill level in a container.

A variety of such field devices are produced and sold by the firm Endress+Hauser.

Field devices in modern manufacturing plants are normally connected via fieldbus systems (HART, Profibus, Foundation Fieldbus, etc.) to superordinated units (e.g. control systems or control units). Among other things, these superordinated units serve for process control, process visualization, process monitoring, as well as for the startup of the field devices. Units which are directly connected to a fieldbus, and which serve for communication with the superordinated units, are also characterized as field devices (e.g. remote I/O, gateways, linking devices).

Fieldbus systems are usually integrated into company networks. In this way, process, and/or field device, data can be accessed from different departments of a company.

For worldwide communication, the company networks can also be connected with public networks, e.g. the Internet.

Modern field devices have a standardized field device interface for communicating with an open fieldbus system, and a proprietary interface for manufacturer-specific communication with a service unit. The service units are frequently small portable computers (laptops, Palms, etc,) commonly known in the field of consumer electronics (home and office computers).

Development in this field of electronics is rapid, especially in the area of interfaces. New interface standards are constantly being developed, such as e.g. USB, Bluetooth, Ethernet, WLAN, Infrared, etc. In order to connect field devices with the newest small computers (laptops, Palms, etc.) available on the market, the field devices must also have corresponding interfaces. This would mean that field devices must be continuously retrofitted to fit the new interfaces.

Such retrofittings can be relatively complex and expensive. It can be even more complex when the old interfaces in field devices already in use must be replaced with new interfaces.

Therefore, an object of the invention is to provide a variable field device for use in automation technology, which can be simply and cost-effectively made suitable for standard and future interfaces.

This object is achieved through the features defined in claim 1. Advantageous further developments of the invention are presented in the dependent claims.

An essential idea of the invention is that, in the case of a field device having a microprocessor for executing a control program and a serial interface for a communicating with a field bus, an additional parallel communication interface is provided in the form of a standard insertion bay for different interface modules.

In a further development of the invention, the communication interface has a 64-pin plug connection.

The parallel communication interface is advantageously connected with the microprocessor CPU via a 16-bit address bus AB and a 24-bit data bus DB. So that current modules from the PC-user area can be employed, the standard insertion bay is constructed for such modules.

The standard insertion bay can be e.g. a PCMCIA card slot.

Advantageously, the interface module is a Bluetooth card, which makes a field device capable of radio communication.

In order to connect the field the device with a fast network, an Ethernet card or an ISDN card is provided as the interface module.

The invention will now be described in greater detail on the basis of an example of an embodiment illustrated in the drawing, the figures of which show as follows:

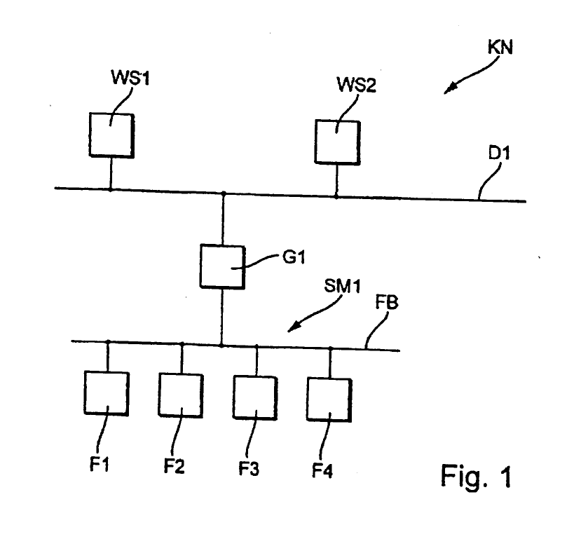

FIG. 1 schematic illustration of a multi-field-device network of process automation technology with multiple field devices; and

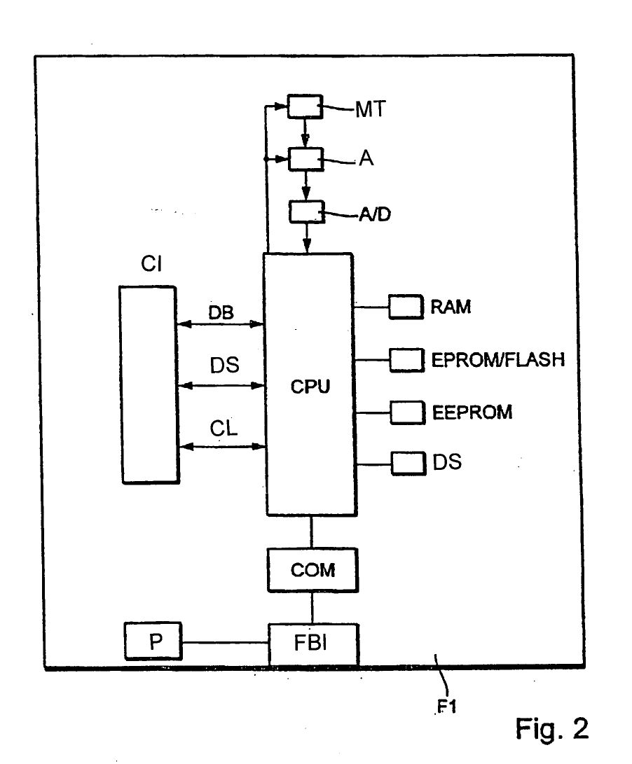

FIG. 2 block diagram of a field device.

FIG. 1 shows an automation-technology communications network KN in greater detail. Multiple computer units in the form of smaller workstations WS1, WS2 are connected to a data bus D1. These computer units serve as superordinated units (control systems or control units) for, among other things, process visualization, process monitoring, and engineering, as well as for servicing and monitoring field devices. The data bus D1 functions e.g. according to the Profibus DP-standard, or the HSE (High Speed Ethernet) standard of Foundation Fieldbus. Data bus D1 is connected with a fieldbus segment SM-1 via a gateway G1, which is also called a linking device or segment coupler. Fieldbus segment SM-1 is composed of multiple field devices F1, F2, F3, F4, which are connected with one another via a fieldbus FB. Field devices F1, F2, F3, F4 can be sensors or actuators. The fieldbus FB functions according to one of the known fieldbus standards Profibus, Foundation Fieldbus, or HART.

FIG. 2 shows a block diagram of a field device of the invention, e.g. F1, in greater detail. A computer unit CPU is connected via an analog-digital converter A/D and an amplifier A with a measuring transducer MT, which provides an analog, electrical signal corresponding to a value of a process variable (e.g. pressure, flow, or fill level). The computer unit CPU is connected with a plurality of memories. A RAM-memory serves as a temporary working memory, a non-volatile EPROM-memory EPROM or flash-memory FLASH, as memory for the control program to be executed in the computer unit CPU, and an EEPROM-memory as memory for calibration and start, parameter values, especially for the setup program of the computer unit CPU.

The control program defines the application-specific functionality of the field device (measured value calculation, envelope-curve evaluation, linearizing of the measured values, diagnostic tasks).

Furthermore, the computer unit CPU is connected with a display/service unit D/S (e.g. LCD-display with 3-5 push-buttons).

For communicating with the fieldbus segment SM1, the computing unit CPU is connected via a communication controller COM with a fieldbus interface FBI. A power supply P supplies necessary energy for the individual electronics components of the field device F1. Except for the interface FBI, the power supply lines to the individual components are not drawn in.

In accordance with the invention, computer unit CPU is connected with a parallel communication interface CI via a 16-bit address bus AB and a 24-bit data bus DB, as well as a plurality of control lines CL. The parallel communication interface CI has 68 connection pins for a plug connection.

Advantageously, the standard insertion bay is constructed for modules from the PC-user area. In this way, the field device F1 can be adapted simply for new communication standards. Currently prevalent cards are PCMCIA-cards. Therefore the standard insertion bay is configured as a PCMCIA-card slot.

The abbreviation PCMCIA stands for “Personal Computer Memory Card International Association,” an association of well-known manufacturers such as, e.g. Intel, Apple, IBM, or Microsoft, who have established a corresponding standard (see www.pcmcia.org).

PCMCIA cards are distinguished by very low current consumption. In order simply to make a field device capable of radio communication, a Bluetooth card is provided as the interface module. When the interface module is an Ethernet- or ISDN-card, the field device can be connected with a fast network (5 KB/s or >1 MB/s).

With the communication interface of the invention, the field device F1 is simply and cost-effectively adapted for different interface standards. Since consumer electronics components, e.g. PCMCIA cards, can be used, no expensive retrofits are necessary in order to adjust the field devices to new communication standards. With the appropriate interface module, the field device F1 can be connected with the newest devices in the field of consumer electronics, such as e.g. laptops, Palms, etc. Costly adjustments at the field device can be omitted.

In an alternative embodiment of the invention, the voltage or power supply of the field device F1 can also be accomplished via the communication interface CI, or via a separate power supply unit.

A PCMCIA Profibus card, for example, can also serve as the interface module, in order to connect the field device FI with an additional fieldbus system.

Such a PCMCIA fieldbus card can also naturally serve to connect the field device FI with the existing fieldbus system FB. In this case, the fieldbus interface FBI and the communications controller COM in the field device FI can be eliminated.

The PCMCIA-controller necessary for a PCMCIA card slot can be integrated into the parallel communication interface CI as hardware, in the form of a chip, or it can be realized as software, in the form of a program module.

With the present invention, it is possible to service field devices for use in automation technology using small computers available on the consumer electronics market, both today and in the future. The term “service” is meant to include use of the functionalities of a field device available to the user (e.g. readout of parameter values, writing parameter values, readout of diagnostic information).

For servicing field devices, a service technician no longer needs a plurality of small computers adapted to the interfaces of individual devices; rather, the technician can service all field devices with one device.

1-7. (canceled)

8. A variable field device for use in automation technology, comprising:
a microprocessor for executing a control program;
a serial fieldbus interface for communicating with a fieldbus;
an additional interface; and
a parallel communication interface, which is embodied as a standard insertion bay for different interface modules.

9. The variable field device as claimed in claim 8, wherein:
said parallel communication interface has a 64-bit plug connection.

10. The field device as claimed in claim 8, wherein:
said parallel communication interface comprises a 16-bit address bus and a 24-bit data bus.

11. The field device as claimed in claim 8, wherein:
said standard insertion bay is formed for modules from the PC-user area.

12. The variable field device as claimed in claim 8, wherein:
said standard insertion bay is a PCMCIA card slot.

13. The variable field device as claimed in claim 8, wherein:
as an interface module, a Bluetooth card is provided, which makes the field device capable of radio communication.

14. The variable field device as claimed in claim 8, wherein:
for communicating data with a fast network, an Ethernet/ISDN card is provided as the interface module.
